(19) United States
(12) Patent Application Publication
(10) Pub. No.: US 2021/0387367 A1
(43) Pub. Date: Dec. 16, 2021

(54) Razor Blade and Method of Making It

(71) Applicant: Edgewell Personal Care Brands, LLC, Chesterfield, MO (US)

(72) Inventors: Sandra Becker, Solingen (DE); Sven Wirtz, Grevenbroich (DE)

(21) Appl. No.: 17/284,812

(22) PCT Filed: Oct. 17, 2019
(86) PCT No.: PCT/US2019/056653

§ 371 Date: Apr. 13, 2021

(30) Foreign Application Priority Data
Oct. 19, 2018 (EP) 18201591.7

(51) Int. Cl. B26B 21/60; B05D 1/02; B05D 7/14; B05D 3/02; B05B 7/08

(52) U.S. Cl. CPC B26B 21/60; B05D 1/02; B05B 7/0815; B05D 3/0218; B05D 7/14

(57) ABSTRACT

In the method for coating a razor blade with a lubricating material, a razor blade is provided having a body portion and a tip end defined by at least one tip surface and a cutting edge. The lubricating material is sprayed on the tip end of the razor blade, wherein spraying the lubricating material is performed steam-aided in that the lubricating material is introduced into a superheated water steam directed towards the tip end of the razor blade. Moreover, a method of making a razor blade by using the afore-mentioned method for coating the razor blade with a lubricating material is provided. Finally, also a razor blade coated in accordance with these methods, and a shaving razor provided with such a razor blade are described.

### BACKGROUND

### Technical Field

The present disclosure relates to a razor blade and a method of making it.

### Background Information

Modern razor blades use multi-layer coatings that allow very close and comfortable shaves. For shaving comfort, a final layer of lubricating material, such as PTFE, on the very tip of the blade became industry standard in the early 1960's (see e.g. GB-A-966 084 and US-A-2007/0124944). Since then, this PTFE coating is an integral element of a razor blade (see e.g. WO-A-2010/081118, WO-A-2010/081119, WO-A-2011/047727, and U.S. Pat. No. 9,393,588). The PTFE is normally applied through a spraying process from a liquid dispersion and the liquid carrier portion is evaporated, thus leaving the PTFE particles adhering on the very tip of the blade. To increase the adhesion of the PTFE, the powder is heated beyond the melting point of the polymer and creates a continuous layer of PTFE along the edge. This process is known in the industry as sintering.

This PTFE coating provides extremely good gliding properties when the edge is moved over the skin, and it reduces the cut-forces during shaving.

These low cut and glide forces result in a high comfort level during shaving. A blade without a PTFE coating would nowadays be judged as unfit for shaving.

In PTFE application, a balance needs to be found with respect to the thickness of the applied PTFE layer. If the PTFE layer is too thin, respectively if the amount of sprayed PTFE is too small, voids between the particles can be caused, that do not heal during sintering. This will cause an improper coverage and a suboptimal shave. Therefore, there is a tendency to increase the amount and thickness of the PTFE to be safe of the void risk.

A PTFE layer that is too thick, on the other hand, causes a suboptimal first shave, because the PTFE needs to be pushed back from the very tip to allow the whisker to become penetrated in an ideal way by the very sharp tip of the razor blade itself. An excess PTFE layer makes the tip appear somewhat blunt. The cohesive strength of the PTFE is due to its chemical nature relatively low, and during the act of shaving this excess PTFE is being removed except an ultra-thin “monolayer” that is required to stay on the very tip to deliver the desired comfortable shave. This effect has been known for a long time as peelback or pushback, but with the changes in PTFE materials and also the increase of number of edges (i.e. blades) in modern shaving systems, the time to create the monolayer has become longer and is causing this slightly less comfortable first shave. This phenomenon is summarized as “First Shave Effect”.

Internal and external shave testing has shown that blade edges are suffering under the (negative) first shave effect and the elimination of this would improve shave performance significantly. It is known that the first shave with a new blade should be the best shave to meet consumer expectations, when they use a new cartridge.

One option to achieve the desired comfortable first shave, is to remove the surplus PTFE material, either mechanically (see e.g. WO-A-2016/057302, WO-A-2016/057473, and US-A-2016/0096282) or chemically (see e.g. U.S. Pat. Nos. 5,985,459 and 7,247,249). These processes are material- and effort-intensive —especially chemical removal is a very costly process, both in terms of investment into equipment, as well as on running costs for the removal chemicals. It makes sense to bring only a small amount of PTFE particles on the blade tip to create almost a PTFE monolayer and the resulting edge requires no “break-in”-period, resulting in excellent shaving comfort from the first shave onwards.

A water-vapor assisted lacquering method is described in WO-A-2005/087387, DE-A-10 2006 019 365, WO-A-2007/122093, GB-A-660233, and GB-A-00608.

It is also well known that prior to the PTFE coating of a razor blade, the razor blade can be coated with other materials as e.g. disclosed in U.S. Pat. Nos. 3,743,551, 3,838,512, 5,488,774, US-A-2007/0186424, WO-A-87/04471, and EP-B-2 731 760.

### SUMMARY OF THE INVENTION

The present disclosure provides a method for coating a razor blade with a lubricating material, comprising the following steps:
providing a razor blade having a body portion and a tip end defined by at least one tip surface and a cutting edge, and
spraying a lubricating material on the tip end of the razor blade,
wherein spraying the lubricating material is performed steam-aided in that the lubricating material is introduced into a superheated water steam directed towards the tip end of the razor blade.

According to the invention, lubricating material, especially lubricating material in the form of particles having preferably a particle size of 0.5 μm or less, more preferably of 0.2 μm or less is disposed on the tip end of a razor blade which tip end is defined by at least one tip surface and a cutting edge and, preferably, by a cutting edge and two tip surfaces both arranged adjacent to the cutting edge on opposite sides of the razor blade. The step of depositing the lubricating material particles is performed steam-aided in that the particles are introduced into a superheated water steam, which water steam is directed towards the tip end of the razor blades and impinges onto the tip end of the razor blade. The spraying of the superheated water steam or water steam together with the lubricating material is performed by means of a spraying applicator which preferably comprises at least one nozzle for exiting the superheated steam. Adjacent to and in the vicinity of this at least one nozzle there is arranged a lubricating material exiting nozzle which introduces lubricating material into the exiting steam. The steam nozzle can have an annular slit-like opening surrounding the lubricating material nozzle. Further steam nozzles can be provided downstream of the exiting steam of superheated steam and lubricating material in order to discharge superheated steam for shaping the stream of superheated water steam and lubricating material. These embodiments are alternative and/or preferred variations for performing the method of the invention.

The spraying process of the invention can be used for lubricating material coating of single edge or double or multiple edge blades for razors or the like cutting blade devices for purposes other than wet or dry shaving razors.

The spraying process is adjusted such that lubricating material particles are smoothly settling onto the tip end of the razor blade. The superheated water steam smoothly contacts the razor blade so that the lubricating material particles sediment or bedew on the tip end of the razor blade. Parameters of the spraying process to be adjusted in order to obtain such a spraying result are particularly:
the pressure of the water steam when exiting its outlet nozzle,
the pressure of the lubricating material or dispersion, when exiting its outlet nozzle, and
the distance of the razor blade from the outlet nozzles.

In a preferred embodiment, the razor blade to be treated by spraying a lubricating material on its tip end is preheated.

Due to the superheated water steam which carries the lubricating material, the lubricating material, while in an almost (or quasi-) dry condition, is deposited on the tip end of the razor blade. No remaining water is on the tip end of the razor blade after the spraying process. In order to further make sure that no water will condense on the razor blade, the razor blade is preheated. Therefore, when impinging on the razor blade, no or at least only little thermal energy is lost in the mixture of steam and lubricating material which is advantageous in order to prevent or reduce condensing of water. The razor blade is preheated up to between about 90° C. and about 180° C., preferably between 110° C. and 140° C.

In another preferred embodiment of the present invention, the superheated water steam is heated up to a temperature at the exit nozzle or nozzles of between about 105° C. and about 200° C., preferably between about 120° C. and about 190° C. and most preferably between about 130° C. and about 170° C., and/or the superheated water steam in a steam generator is at a pressure of about 1.5 bar to about 2 bar.

In another embodiment of the present invention, for spraying the lubricating material on the tip of a razor blade, several razor blades are arranged side-by-side as a stack with the tip ends facing the same direction, or a plurality of razor blades are arranged as an integral razor blade ribbon, wherein the razor blade ribbon is coiled. In both cases, for coating the tip ends of all the blades of the stack or the coil, the spraying applicator and the blade material (stack or coil) are displaced relative to each other. In case of the stack, the relative movement can be forth and back with a lateral shift between the strokes. When the blade material is coiled, the spraying applicator can be moved spirally from the center of the coil to its periphery (or vice versa) or the coil is rotated and the spraying applicator is moved radially relative to the coil and over it. In these cases, the rotational speed of the coil is to be adjusted so that the amount of lubricating material sprayed onto the tip end of the coiled razor blade ribbon is the same per length unit of the razor blade ribbon. That means that the rotational speed of the coil is reduced the more the spraying applicator moves radially outwardly or is increased the more the spraying applicator moves radially inwardly. As an alternative, the relative movement of the razor blade coil and the spraying applicator is performed in concentric circles with a radially inwardly or radially outwardly displacement after completion of e.g. each circle for a number of circles. If the razor blade coil stands still and the spraying applicator moves in concentric circles or spirally, the speed of the spraying applicator can be kept constant. However, it is also possible that razor blades are treated individually in that a plurality of separated razor blades are treated one after the other, or in that a plurality of razor blades are arranged as an integral razor blade ribbon which is passed along a spraying station or spraying applicator and through the superheated water steam exiting from the spraying applicator or spraying station.

In a further embodiment of the present invention, the lubricating material is provided as a dispersion of lubricating material particles in a liquid, especially comprising water, wherein the dispersion is introduced into the water steam. Moreover, in this preferred embodiment it is further preferred that the dispersion is kept at a temperature between about 20° C. and about 50° C. and/or the dispersion comprises between about 1% dispersion weight and about 5% dispersion weight, preferably between 1.5% dispersion weight to about 2.5% dispersion weight of lubricating material particles and between at least about 95% dispersion weight and about 99% dispersion weight liquid, especially water, preferably about 97.5% dispersion weight of liquid, wherein the liquid comprises between about 99% and about 99.8% liquid weight of water, preferably 99.5% liquid weight water, and between about 1% liquid weight and about 0.2% liquid weight of stabilizer, preferably about 0.5% liquid weight of stabilizer, wherein the stabilizer preferably is a tenside. The stabilizer is advantageous in that the mixture of lubricating material particles and the liquid, i.e. the dispersion is more homogenized.

Also, the dispersion can be preheated so as to support maintaining the dry condition of the mixture of the water steam and the dispersion with its weight percentage of its liquid compared to the steam volume is rather low.

The step of introducing the dispersion into the water steam or vapor can be performed by spraying the dispersion into the water steam and/or by sucking the dispersion into the water steam according to the Venturi effect and due to the velocity of the water steam flow.

In another preferred embodiment of the present invention, the water steam is provided by a steam generator and is guided through a heated conduit to a spraying applicator in which the lubricating material is merged into the water steam and by which both are sprayed onto the tip end of the razor blade. This provides that the water steam is kept at the superheated temperature when exiting the spraying applicator.

By means of the razor blade of the present invention and the method of the invention, it is surprisingly possible that a very thin layer of lubricating material particles can be deposited on the tip end of the razor blade. Ideally, the layer comprises only lubricating material particles arranged side by side on the tip end of the razor blade. The lubricating material particles adhere to the surface of the tip end in order to mechanically stabilize this ideally single layer of lubricating material particles, the razor blade with the lubricating material particles on its tip end is treated by sintering the lubricating material so as to create a lubricating material coating on the tip end. According to tests made in conjunction with the present invention, the thickness of the lubricating material coating on the razor blade is less than about 1.5 μm, preferably between about 0.1 μm and about 1 μm, most preferably between about 0.25 μm and about 0.75 μm and wherein the cutting edge is almost completely covered by lubricating material and wherein at least 70% of the at least one tip surface or of each tip surface is covered by lubricating material up to a distance of 100 μm, preferably 70 μm from the cutting edge.

Generally, all known kinds of lubricating material used for improving gliding of a razor blade on a skin to be shaved can be employed according to the present invention. Most preferably, the lubricating material comprises fluoropolymers, polytetrafluoroethylene (PTFE), polytrifluorochloroethylene (PCTFE), poly-vinylidenfluoride (PVDF), tetrafluoroethylene-perfluor-methyvinylether (MFA), poly[tetrafluoroethylene-perfluoro(alkoxyvinylether)]) PFA, ethylene-tetra-fluoroethylene-hexafluoropropylene-terpolymer EFEP, perfluoromethylvinyl-ether, perfluoroethylvinylether, perfluoropropylvinylether, perfluorobutyl-vinylether, perfluorobutylethylene, perfluorohexylethylene, ethylene-tetra-fluoroethylen-copolymer (ETFE), tetrafluoroethylene-hexafluoropropylen-copolymer (FEP) and a copolymer of per-fluoroethylene and per-fluoro-propylene.

In razor blades, multi-layer coatings that allow very close and comfortable shaves are basically known, as already mentioned above. Accordingly, those multi-layer coatings and corresponding coating technologies can be used for preparing a razor blade so as to be coated by lubricating material (typically as the final coating step) according to the present invention. Therefore, in preferred embodiments of the present invention, providing a razor blade comprises providing a substrate (typically of metal) having a body portion and a tip end defined by at least one tip surface and a cutting edge, wherein the cutting edge and at least an area of the at least one tip surface adjacent to the cutting edge are coated with an interlayer, a hard coating layer on the interlayer and, optionally an overcoat layer on the hard coating layer or are coated with a hard coating layer applied to the cutting edge and at least an area of the at least one tip surface adjacent to the cutting edge and, optionally, an overcoat layer applied onto the hard coating layer.

Accordingly, the following variants of coatings are possible:
substrate—lubricating material
substrate—hard coating—lubricating material
substrate—interlayer—hard coating—lubricating material
substrate—interlayer—hard coating—overcoating—lubricating material

More specifically, according to the present invention it can be provided that providing a razor blade comprises providing a substrate having a body portion and a tip end defined by at least one tip surface and a cutting edge, wherein the cutting edge and at least an area of the at least one tip surface adjacent to the cutting edge are coated with an interlayer which comprises niobium, chromium, titanium, silver, zirconium, mixtures of different metals such as chromium and titanium or silver and or nitrides or carbides of these metals and alloys or other ceramics, a hard coating layer onto the interlayer with the hard coating layer comprising diamond, a diamond-like material or a ceramic coating layer, e.g. chromium nitride, chromium carbide, titanium nitride, titanium carbide, zirconium oxide, zirconium nitride, tungsten carbide, tungsten nitride or other ceramics, and, optionally an overcoat layer onto the hard coating layer with the overcoat layer comprising a metal or a metal alloy, e.g. chromium, titanium, silver, gold, niobium, zirconium, tungsten or mixtures of the above metals. However, the invention can also be used for lubricating material coating of a non-precoated substrate, i.e. on the bare substrate (typically of metal).

In addition to the advantages of the present invention mentioned before, it is to be noted that the step of spraying the mixture of water steam and lubricating material particles can be performed within natural atmosphere. No specific gas atmosphere like e.g. a protective atmosphere is necessary for the step of depositing the lubricating material particles onto the tip end of the razor blade.

In another variant of the present invention, a method of making a razor blade is provided comprising the steps of
providing a non-coated or a pre-coated substrate having a body portion and a tip end defined by at least one tip surface and a cutting edge,
spraying a lubricating material onto the tip end of the substrate according to the method as explained before, and
sintering the sprayed lubricating material to provide a lubricating material coating.

Moreover, the present invention provides a razor blade comprising
a non-coated or a pre-coated substrate having a body portion and a tip end defined by at least one tip surface and a cutting edge, and
an outer lubricating material coating layer,
wherein the razor blade is obtainable by the manufacturing method as defined before.

In a preferred embodiment, the razor blade comprises at least one of an interlayer, a metallic or a hard coating layer, and optionally an overcoat layer, wherein said layer or layers is/are arranged between the substrate and the outer coating layer.

In a further preferred embodiment, the thickness of the outer lubricating material coating layer is less than about 1.5 μm, preferably between about 0.1 μm and about 1 μm, most preferably between about 0.25 μm and about 0.75 μm.

Moreover, in another preferred embodiment, the cutting edge is almost completely covered by lubricating material and wherein at least 70% of the at least one tip surface or of each tip surface is covered by lubricating material up to a distance of 100 μm, preferably 70 μm from the cutting edge.

In another preferred embodiment, the hard coating layer comprises diamond, a diamond-like material or a ceramic coating layer, e.g. chromium nitride, chromium carbide, titanium nitride, titanium carbide, zirconium oxide, zirconium nitride, tungsten carbide, tungsten nitride or other ceramics.

In a still further preferred embodiment, the order of the layers on the substrate is the interlayer, the hard coating layer, and the outer lubricating material coating layer, or the order of the layers on the substrate is the interlayer, the hard coating layer, the overcoat layer, and the outer lubricating material coating layer.

Finally, the present invention provides a shaving razor comprising a handle, a housing and at least one razor blade manufactured according to the method as explained before and/or having the features as defined before. The razor can comprise a housing in the form of a replaceable or non-replaceable cartridge having a frame with at least one and preferably more than one razor blades mounted in the frame of plastic or other known material, preferably manufactured by way of injection molding technology. Also, the razor can have a housing which can accommodate at least one replaceable double edge razor blade.

In a further preferred embodiment said housing contains at least two to ten razor blades arranged parallel to each other.

In a preferred embodiment a plurality of blade segments are arranged within said housing.

According to the invention, the lubricating material particles are carried by means of a superheated water vapor stream and melt only when or after contacting the blade which preferably is preheated so that the water vapor does not change its state of aggregation and, accordingly, does not condense which means that nearly no water is sedimented on the blade or the lubricating material particle layer. The individual parameters like e.g. temperature of the superheated water vapor, temperature of the preheated blade, flowrate of the water vapor stream, size of the lubricating material particles, density of particles per surface unit and/or volume unit, amount of lubricating material particles per volume of water vapor, distance between exit opening of the spraying applicator to the blade to be coated, and speed of relative movement between the spraying applicator and the blade ribbon or blade length to be coated have to be determined experimentally in order to obtain a lubricating overcoating of a blade having the desired properties defined by the blade manufacturer.

### BRIEF DESCRIPTION OF THE FIGURES

The present invention will be explained in more detail referring to the drawings in which

FIG. 1 is a planar front view of a razor assembly including a razor cartridge and a handle,

FIG. 2 is a planar top view of the razor cartridge shown in FIG. 1,

FIG. 3 is a perspective view of a razor cartridge,

FIG. 4 is a planar top view of an exemplary razor blade that can be used with the present methods,

FIG. 5 is a planar side view of an exemplary razor blade that can be used with the present methods,

FIG. 6 is a diagrammatic illustration of a razor blade tip end with an initial lubricating material particle layer sprayed by means of a spraying applicator,

FIG. 6a is an enlarged view of the nozzle part of the spraying applicator of FIG. 6,

FIG. 7 is a diagrammatic illustration of a razor blade tip end with a lubricating material surface coating after sintering the particle layer as illustrated in FIG. 6,

FIG. 8 is a diagrammatic illustration of a stack of razor blades disposed within a fixture embodiment with the relative movement of both the fixture and the spraying applicator indicated, and

FIG. 9 is a diagrammatic illustration of a coiled razor blade ribbon with the relative movement of both the fixture and the spraying applicator indicated.

### DETAILED DESCRIPTION OF PREFERRED EMBODIMENTS

The present disclosure includes methods, and embodiments thereof, for manufacturing a razor blade with a surface coating, and more specifically to methods for applying a surface coating disposed on a surface of a razor blade.

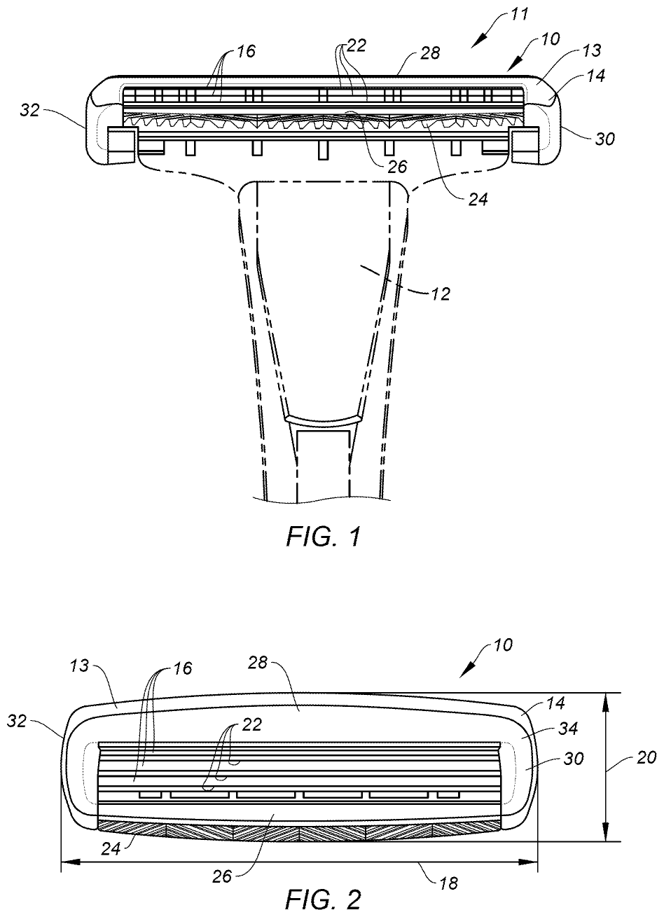

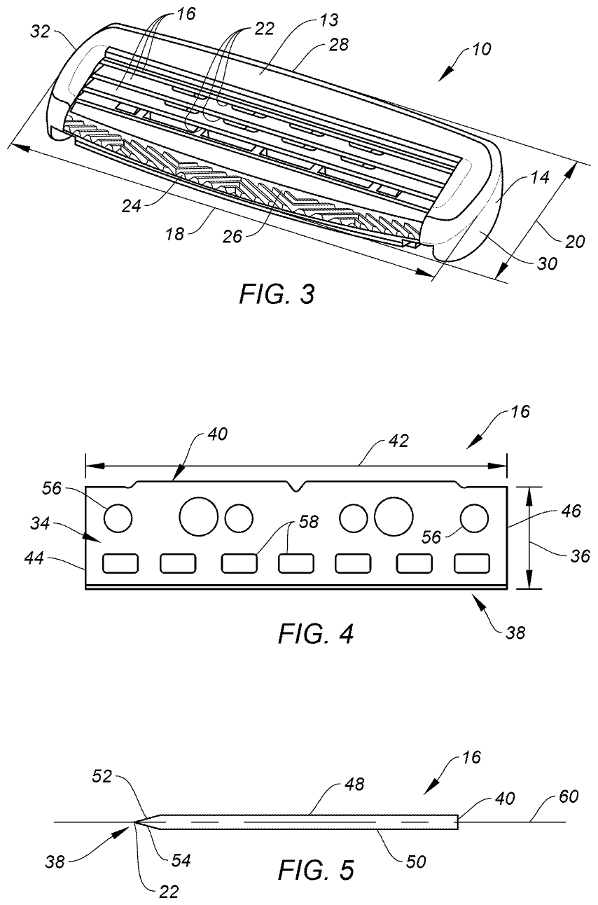

Referring to FIGS. 1 to 3, an exemplary razor cartridge 10 having a housing 13 is shown to facilitate the description provided herein. The present disclosure is not limited to this particular razor cartridge embodiment and can also be used for housings of razors having at least one double edge razor blade which can be replaceable or not. The term housing shall comprise both replaceable and non-replaceable housings which can be connected to the handle pivotably or non-pivotably. The razor, razor handle, and housing as well as razor blade(s) can have any design and can be made from any suitable material(s) and can be manufactured in any technology known in the field of wet and dry shaving razors.

The exemplified razor cartridge 10 pivotally or rigidly mounts on a handle 12 (shown in phantom in FIG. 1). In some applications, the razor cartridge 10 is a disposable portion of a razor assembly 11 intended to be detachable from a reusable handle 12. In other applications, the razor cartridge 10 and a handle 12 are combined into a unitary disposable razor assembly 11. In the latter form, the handle 12 and cartridge 10 are not intended to be detached from one another during normal use. The cartridge can have any kind of housing 13 manufactured from any material and by any technology as basically known in the field of dry and wet shaving razors.

The razor cartridge 10 includes a body 14 and one or more razor blades 16, and has a length 18 and a width 20. Each of the one or more razor blades 16 has a lengthwise extending cutting edge 22. The present disclosure is not limited to any specific cutting edge and/or razor blade configuration, however; e.g., the present disclosure is applicable to linear cutting edges, non-linear cutting edges, cutting edges extending around the perimeter of apertures, integrally bent razor blades, razor blades mounted on a bent or not bent blade support etc. The razor cartridge 10 preferably also includes a guard 24. For the sake of clarity, the terms “forward” and “aft” as used herein are defined in terms of the orientation in which a blade encounters a user's skin when the blade is used conventionally; e.g., when a razor blade 16 is used in a conventional manner, the blade will move in a direction from forward to aft relative to a point on the user's skin—a forward blade element will encounter the point before an aft blade element. The body 14 includes a forward portion 26, an aft portion 28, a first lateral portion 30, and a second lateral portion 32. The forward portion 26 is disposed between the guard 24 and the one or more razor blades 16. The aft portion 28 (sometimes referred to as the “cap”) is disposed aft of the one or more razor blades 16. The first lateral portion 30 and second lateral portion 32 are disposed on opposite lateral sides of the one or more razor blades 16, and both extend between the forward portion 26 and the aft portion 28. The cartridge or housing 13 can also be provided with interblade guards and with razor blades all facing the same direction or comprising several groups facing in different directions among which also opposite directions exist.

A razor blade 16 according to the present disclosure can assume a variety of configurations, each including a body 34 having a width 36 extending between a tip end 38 and an aft end 40, and a length 42 extending between a first lateral edge 44 and a second lateral edge 46. The body 34 further includes an upper body surface 48 and a lower body surface 50, which body surfaces 48, 50 extend widthwise between the tip end 38 and the aft end 40, and lengthwise between the first and second lateral edges 44, 46. The razor blade description provided herein and shown in the Figures is included to facilitate the understanding of the present disclosure. The present disclosure is not limited to this particular razor blade embodiment.

Referring to FIGS. 4 and 5, the tip end 38 is typically defined by a first tip surface 52, a second tip surface 54, and a cutting edge 22. The first and second tip surfaces 52, 54 converge at the cutting edge 22, each extending aftward to the respective body surface 48, 50 of the razor blade 16. Strictly speaking, in many instances there can be a small radiused surface (sometimes referred to as a “tip radius”) at the convergence of the first and second tip surfaces 52, 54. The tip end 38 can also be alternatively configured to have a single tip surface extending between the cutting edge 22 and a body surface of the razor blade 16. The present disclosure is not limited to any particular blade tip configuration. The razor blade 16 shown in FIG. 4 includes a plurality of apertures that extend through the blade, between the body surfaces of the blade. Some of the apertures 56 can be used to locate/secure the blades 16 within the razor cartridge, and other apertures 58 are wash-through ports that facilitate removal of shaving debris. The razor blade 16 can also be described as having a widthwise extending centerline 60 that is typically parallel to the body surfaces 48, 50 in at least the region proximate the tip end 38. Razor blades 16 are often, but not always, manufactured from a stainless steel material, and can as indicated above include a coating comprising one or more materials such as diamonds, amorphous diamonds, diamond-like carbon (DLC) materials, nitrides, carbides, oxides, ceramics, or the like, to improve strength, corrosion resistance and shaving ability. The present method for manufacturing a razor blade 16 with a surface coating, including a method for forming a surface coating adhered to a surface of the razor blade 16, is not limited to practice on any particular razor blade configuration, nor any particular razor blade tip configuration or cutting edge geometry, or blade material.

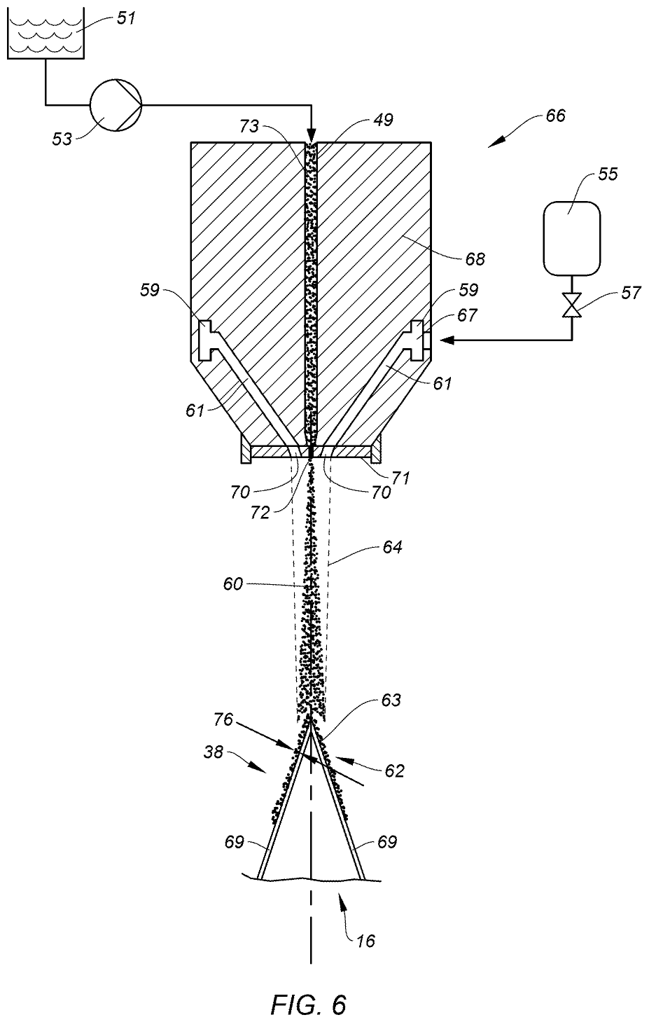

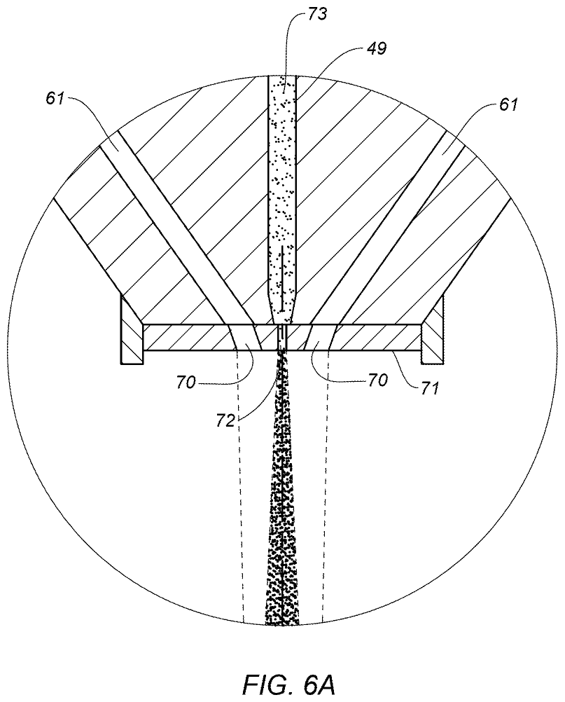

Referring to FIG. 6 and FIG. 6a, an embodiment of the spraying process according to the present invention is illustrated. The result of the spraying process is an initial surface coating 62 of lubricating material particles 63 which form nearly a monolayer or merely a few layers of lubricating material particles 63 arranged side by side and covering the tip end 38 or at least a part of the tip end 38 of the razor blade 16. The lubricating material particles 63 are carried by a stream 64 of steam 67 of water sprayed by a spraying applicator 66 having a body 68 with at least two nozzles 70, 72 in a nozzle plate 71 e.g. screwed to the body 68. Superheated steam within steam generator 55 heated up to between about 105° C. and about 200° C., or between about 120° C. and about 190° C., preferably between 130° C. and 170° C., flows through a flow meter 57 (or a flow regulator) or flows directly into an internal ring channel or the like manifold 59 of the spraying applicator 66 and further through a channel 61 to nozzle 70 which preferably is shaped like an annular slit. Surrounded by nozzle 70 is arranged a nozzle 72 for exiting a dispersion 73 of water, stabilizer, and lubricating material particles. Fed to the spraying applicator 66 from a reservoir 51 by means of a pump 53 (or flow meter or pressure regulator if the dispersion 73 within the reservoir 51 is under pressure) through a channel 49 within the spraying applicator 66. Both the superheated steam as well as the dispersion are fed to the spraying applicator 66 (not shown). The dispersion is stored in a tank (not shown) and is fed by means of a pump or the like feeding device to the body 68 of the spraying applicator. The superheated steam is generated in a steam generator and is fed through a tube to the body 68, wherein the tube is heated in order to keep the superheated steam at the desired temperature. As an alternative, the dispersion can also be permanently under the certain pressure and the amount of dispersion per time unit (i.e. the flow rate) exiting the nozzle can be controlled by a flowmeter or the like through flow regulator or adjusting device. The same is true for controlling the flow rate of the superheated water steam exiting the steam nozzle.

The initial lubricating material particle surface coating 62 according to the present disclosure can comprise a variety of different materials. Useful surface coating materials include, but are not limited to, fluoropolymers. A particularly useful fluoropolymeric surface coating material is polytetrafluoroethylene (“PTFE”). Specific examples of fluoropolymers include ZONYL® MP1100, MP1200, MP1600, and KRYTOX® LW1200 and Dry Film® LW2120 brand polytetrafluoroethylene powders manufactured by E.I. DuPont de Nemours and Company, U.S.A, now Chemours Company. Other non-limiting examples of surface coating materials include silicon, organosiloxane gel, etc. The present method is not limited to using any particular type of surface coating material, provided the material can be processed in the manner described below. To facilitate the description of the present method, the surface coating material will be discussed as being PTFE. As indicated above, however, the present method is not limited to use with PTFE type surface coating materials.

The present method uses the nebulizing process and comprises, as explained above, the superheated steam stream 64 including the dispersion sprayed into the steam stream. However, the invention is not limited to introducing the lubricating material particles into the steam stream 64 by way of spraying a dispersion into the steam stream. However, a particularly useful application process is one in which surface coating materials (e.g., PTFE particles) are initially disposed in a dispersion. The dispersion is deposited on the tip end 38 nearly as a single layer or as a few layers of lubricating material particles 63.

According further to the present disclosure, the blade 16 or blades 16 with the deposited initial lubricating material particles surface coating 62 are subjected to a thermal sintering process that includes heating the blade and deposited surface material coating to a predetermined temperature for a period of time adequate for the PTFE particles to fuse together and to adhere to the razor blade 16 and in some instances to drive off the dispersing media, thereby forming a sintered form of the aforesaid initial lubricating material particle surface coating 62. During the sintering process, the thickness of the surface coating can decrease from that of the initial lubricating material particle surface coating 62.

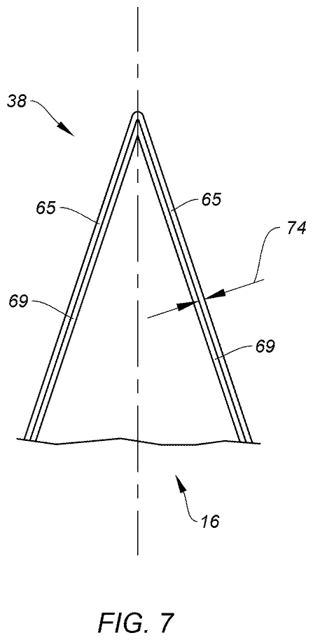

FIG. 7 shows the final surface coating layer 65 after the sintering process and having a thickness (see reference numeral 74).

Both in FIGS. 6 and 7, reference numeral 69 represents one or more (e.g. hard) under-coating layers or interlayers as described above, which are overcoated by the surface coating layer 65. However, such additional under-coating layer(s) or interlayer(s) is optional and, accordingly, the surface coating layer 65 can also be applied directly to the material (like e.g. steel or stainless steel or other metal or ceramic) of the blade.

The superheated steam stream 64 directed at the blade tip end 38 can be configured in a single defined stream that impacts onto substantially all of the lengthwise extending blade tip end 38, or a plurality of streams 64 oriented to collectively impact substantially all of the lengthwise extending blade tip end 38, or a stream 64 having a geometry (e.g., diameter) that is smaller than the length of the blade 16 and is moved relative to the blade 16 (or vice versa), or any combination thereof. The steam stream 64 can be constantly or intermittently applied; e.g., pulsed. The steam stream 64 is typically produced from one or more nozzle stamps having a nozzle exit orifice positioned a predetermined distance from blade tip end 38 being processed. The geometry of the steam stream 64 exiting from the nozzle orifice is a function of the fluid and flow parameters, and also of the geometry of the nozzle orifice. The nozzle orifice geometry is chosen in concert with the fluid and flow parameters so as to be adequate for the chosen steam stream 64 to sediment the initial lubricating material particle surface coating 62 at the tip end 38. Additional fluid outlet nozzles (not shown) at the spraying applicator or downstream of the steam flow can be used to shape the steam flow and the size of the steam flow can be altered and adopted to the surface to be covered with the lubricating material.

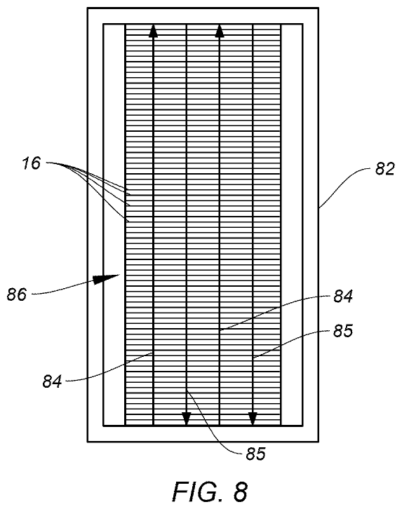

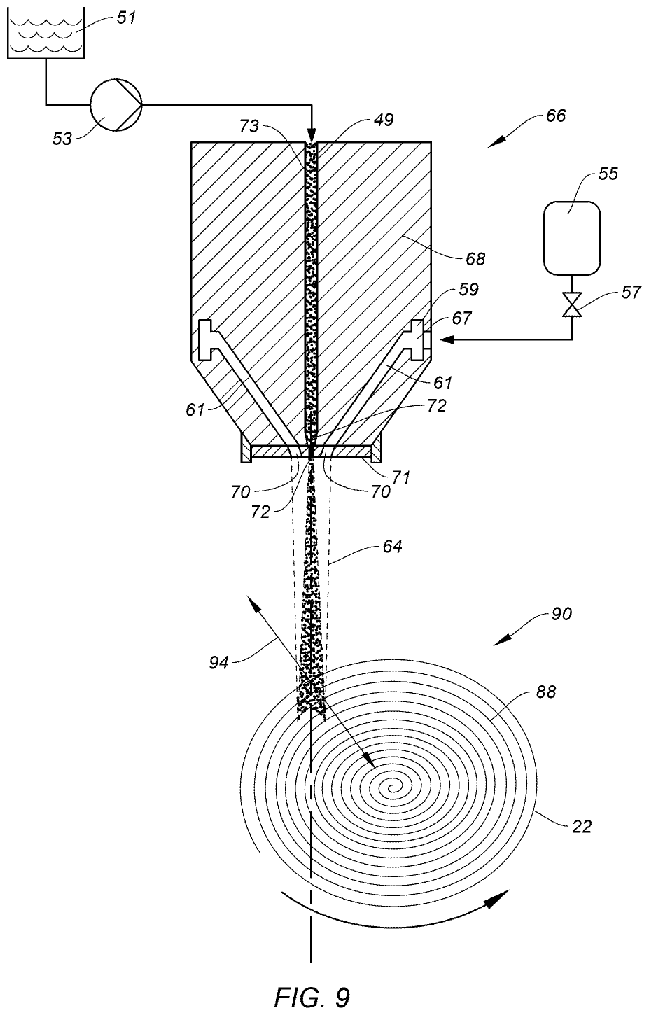

Referring to FIG. 8, according to an aspect of the present disclosure a method for producing a lubricating material surface coating on a razor blade 16 includes mounting a plurality of razor blades 16 (i.e., a “stack 86” of blades) within a fixture 82 that allows the blades 16 to be stacked in the same orientation, with the blade tip ends 38 exposed. In one embodiment, the fixture 82 may include one or more blade retaining members; e.g., at least two rods that extend through apertures (e.g., through location/mounting apertures 56, or through wash-out ports 58) within the blades 16. The fixture 82 can provide spacers (not shown) disposed between each razor blade 16, or the razor blades 16 are arranged so that respective adjacent blades contact each other. In this method, the steam stream 64 is directed at the blade tip ends 38 disposed in the fixture 82 in a manner that causes the particles 63 to form the initial lubricating material particle surface coating 62 at the tip end 38. The above-described fixture 82 is a non-limiting example of a fixture that can be used to treat a plurality of blades 16 in a single process as opposed to a single blade surface treating process.

The fixture 82 is selectively mountable relative to a device operable to preheat the razor blades 16 within the fixture 82 to a temperature, specifically up to between about 90° C. and about 180° C., preferably between 110° C. and 140° C., so as to prevent condensation of the superheated steam stream 64. In addition, for example, the fixture 82 holding the stack 86 of blades 16 can be selectively mounted within a furnace operable to heat the stack 86 of razor blades 16 with surface coating material in order to sinter the initial lubricating material particle surface coating 62. After sintering, the sintered lubricating material surface coating layer 65 can have a thickness 76 of less than about 1.5 μm, preferably between about 0.1 μm and about 1 μm, most preferably between about 0.25 μm and about 0.75 μm and preferably completely covers the tip end 38, wherein the cutting edge is almost completely covered by lubricating material and wherein at least 70% of the at least one tip surface or of each tip surface is covered by lubricating material up to a distance of 100 μm, preferably 70 μm from the cutting edge. The thickness 76 can be determined by suitable methods such as atomic force microscopy (AFM).

In FIG. 8 the arrows 84, 85 show the relative forth and back movements of the spraying applicator 66 and the fixture 82 with lateral displacement after each forth and/or back movement path. However, relative forth and back movement could also take place e.g. orthogonal to the arrows 84, 85.

FIG. 9 schematically shows a spraying process according to another embodiment of the invention in which the spraying applicator 66 is used for applying particles of lubricating material in a sediment-like manner onto the tip end of a coiled razor blade ribbon 88. The coil 90 and the spraying applicator 66 are moved relative to each other so that all the tip end length of the ribbon can be covered with the lubricating material particles. For example, the coil 90, in the direction of arrow 92 (or in the reverse direction) can be rotated underneath the spraying applicator 66. The rotation speed needs to be adopted depending on the position of the spraying applicator 66 over the coil radius when the spraying applicator 66 is moved radially (see arrow 94). This helps to keep the spray volume per time unit and/or per tip end length unit constant from the outer to the inner of the coil without adjusting the flow rate/amount of medium that is sprayed. As an alternative, the spraying applicator 66 can be moved above the coil in concentric circles (with radial displacement after e.g. each circle) or in a spiral pattern.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

### LIST OF REFERENCES

10 razor cartridge
11 assembly
12 handle
13 housing
14 body
16 blade
18 length
20 width
22 cutting edge
24 guard
26 forward portion
28 aft portion
30 lateral portion
32 lateral portion
34 body
36 width
38 tip end
40 aft end
42 length
44 lateral edge
46 lateral edge
48 body surface
49 channel
50 body surface
51 reservoir
52 tip surface
53 pump
54 tip surface
55 steam generator
56 apertures
57 flow meter
58 apertures
59 ring channel (manifold)
60 centerline
61 channel
62 initial lubricating material particle surface coating
63 particles
64 stream
65 sintered coating layer
66 spraying applicator
67 steam
68 body of the spraying applicator
69 under-coating layer and/or interlayer
70 nozzles
71 nozzle plate
72 nozzles
73 dispersion
74 thickness of the sintered coating layer
76 thickness of initial lubricating material particle surface coating layer
82 fixture for razor blade stack
84 movement arrow
85 movement arrow
86 stack
88 coiled razor blade ribbon
90 coil
92 movement arrow
94 movement arrow

1. A method for coating a razor blade with a lubricating material, comprising the following steps:
providing a razor blade (16) having a body portion (14) and at least one tip end (38) defined by at least one tip surface (52, 54) and a cutting edge (22), and
spraying a lubricating material on the tip end (38) of the razor blade (16),
wherein spraying the lubricating material is performed steam-aided in that the lubricating material is introduced into a superheated water steam (67) directed towards the tip end (38) of the razor blade (16).

2. The method according to claim 1, wherein the razor blade (16) is preheated.

3. The method according to claim 1, wherein the superheated water steam (67) is heated up to between about 105° C. and about 200° C., preferably between about 120° C. and about 190° C., preferably between about 130° C. and about 170° C., and/or wherein the superheated water steam (67) is pressurized at a value of between about 1.2 bar and about 2.5 bar, preferably between about 1.5 bar and about 2 bar.

4. The method according to claim 2, wherein the razor blade (16) is preheated up to between about 90° C. and about 180° C., preferably between about 110° C. and about 140° C.

5. The method according to claim 1, wherein several razor blades (16) are arranged side-by-side as a stack (86) with the tip ends (38) facing the same direction or wherein a plurality of razor blades (16) are arranged as an integral razor blade ribbon (88), wherein the razor blade ribbon (88) is coiled.

6. The method according to claim 1, wherein the lubricating material is provided as a dispersion (73) of lubricating material particles (63) in a liquid, especially comprising water, wherein the dispersion (73) is introduced into the water steam (67).

7. The method according to claim 6, wherein the dispersion (73) is sprayed into the water steam (67) and/or the dispersion (73), due to the flow of water steam (67), is sucked into the water steam (67).

8. The method according to claim 6, wherein the dispersion (73) is kept at a temperature between about 20° C. and about 50° C. and/or the dispersion (73) comprises between about 1% dispersion weight and about 5% dispersion weight, preferably between 1.5% dispersion weight to about 2.5% dispersion weight of lubricating material particles and between at least about 95% dispersion weight and about 99% dispersion weight of liquid, especially water, preferably about 97.5% dispersion weight of liquid, wherein the liquid comprises between about 99% and about 99.8% liquid weight water, preferably 99.5% liquid weight water, and between about 1% liquid weight and about 0.2% of liquid weight stabilizer, preferably about 0.5% of liquid weight stabilizer, wherein the stabilizer preferably is a tenside.

9. The method according to claim 1, wherein the water steam (67) is provided by a steam generator (55) and is guided through a heated conduit to a spraying applicator (66) in which the lubricating material is merged into the water steam (67) and by which both are sprayed onto the tip end (38) of the razor blade (16).

10. The method according to claim 1, further comprising sintering the lubricating material sprayed onto the tip end (38) of the razor blade (16) so as to create a lubrication material coating (65) on the tip end (38) of the razor blade (16).

11. The method according to claim 1, wherein the thickness of the lubricating material coating (65) on the razor blade (16) is less than about 1.5 μm, preferably between about 0.1 μm and about 1 μm, most preferably between about 0.25 μm and about 0.75 μm.

12. The method according to claim 1, wherein providing a razor blade (16) comprises providing a substrate having a body portion (48, 50) and a tip end (38) defined by at least one tip surface (52, 54) and a cutting edge (22).

13. The method according to claim 12, wherein the cutting edge (22) and at least an area of the at least one tip surface (52, 54) adjacent to the cutting edge (22) are coated with an interlayer, a hard coating layer applied onto the interlayer and, optionally an overcoat layer applied onto the hard coating layer or are coated with a hard coating layer applied to the cutting edge and at least an area of the at least one tip surface (52, 54) adjacent to the cutting edge (22) and, optionally, an overcoat layer applied onto the hard coating layer.

14. The method according to claim 1, wherein providing a razor blade (16) comprises providing a substrate having a body portion (34) and a tip end (38) defined by at least one tip surface (52, 54) and a cutting edge (22), wherein the cutting edge (22) and at least an area of the at least one tip surface (52, 54) adjacent to the cutting edge (22) are coated with an interlayer which comprises niobium, chromium, titanium, silver, zirconium, mixtures of different metals such as chromium and titanium or silver and or nitrides or carbides of these metals and alloys or other ceramics, a hard coating layer applied onto the interlayer with the hard coating layer comprising diamond, a diamond-like material or a ceramic coating layer, e.g. chromium nitride, chromium carbide, titanium nitride, titanium carbide, zirconium oxide, zirconium nitride, tungsten carbide, tungsten nitride or other ceramics, and, optionally an overcoat layer applied onto the hard coating layer with the overcoat layer comprising a metal or a metal alloy, e.g. chromium, titanium, silver, gold, niobium, zirconium, tungsten or mixtures of the above metals.

15. The method according to claim 1, wherein the step of spraying is performed within a natural atmosphere.

16.-20. (canceled)
